(19) United States
(12) Patent Application Publication
(10) Pub. No.: US 2018/0005285 A1
(43) Pub. Date: Jan. 4, 2018

(54) TOKENIZATION AND DYNAMIC TRANSACTION CLASSIFICATION

(71) Applicant: PAYPAL, INC., San Jose, CA (US)

(72) Inventors: Srivathsan Narasimhan, San Jose, CA (US); Akshay Sanjeevaiah Krishnaiah, San Jose, CA (US); Avik Chatterjee, Scottsdale, AZ (US)

(21) Appl. No.: 15/199,478

(22) Filed: Jun. 30, 2016

(51) Int. Cl. G06Q 30/06; G06Q 30/02

(52) U.S. Cl. CPC G06Q 30/0605; G06Q 30/0256; G06Q 30/0272

(57) ABSTRACT

A database of prior user transactions may enable and present opportunities to dynamically classify a current user transaction according to particular information or characteristics of that transaction and/or the user conducting the current transaction. Results of previous transactions can be correlated and/or aggregated with other transactions, allowing predictive relationships to indicate an approximated user goal for a particular transaction. Based on the approximated user goal, a limited timespan electronic market may be established. This electronic market may enable additional transactions with the user that correspond to the approximated user goal.

### BACKGROUND

This disclosure relates to the field of transaction classification and to establishing a limited timespan electronic market based on an approximated transaction goal.

### BRIEF DESCRIPTION OF THE DRAWINGS

FIG. 1 illustrates a block diagram of a system including a user, an entity with whom the user may transact, and a classification server that may determine an approximated transaction goal for a transaction between the user and the entity, according to some embodiments.

FIG. 2 illustrates a block diagram of a system similar to that of FIG. 1, with additional detail, according to some embodiments.

FIGS. 3A-3D illustrate information flow diagrams relating to a limited timespan electronic market, according to some embodiments.

FIG. 4 is a flow diagram illustrating operations that relate to determining an approximated transaction goal and generating a limited timespan electronic market, according to some embodiments.

FIG. 5 illustrates aspects of a classification engine, according to some embodiments.

FIG. 6 is a flow diagram illustrating further operations that relate to a limited timespan electronic market, according to some embodiments.

FIG. 7 is a block diagram of one embodiment of a computer readable medium.

FIG. 8 is a block diagram of one embodiment of a system.

### DETAILED DESCRIPTION

Electronic transactions are sometimes performed inefficiently, or are simply under-utilized in frequency, due to a lack of information. As a result of such inefficiencies, a user who has engaged in a first transaction may face obstacles in attempting to complete one or more other transactions that share a temporal, contextual, and/or geographical nexus with the first transaction.

As described herein, a limited timespan electronic market may be created for a particular user, with this market providing increased value on both sides of a transaction (buyer and seller). For example, users often have to visit multiple travel related sites (or the same site multiple times) in order to book various services or items relating to a particular trip, even after they have confirmed a booking a major reservation corresponding to this trip, such as a hotel reservation or an airline reservation. Users may not be thinking about other travel details (such as car rentals, restaurant reservations, tour reservations, etc.) at the time that they secure the major reservation, thereby creating inefficiency for those users and possibly allowing the users to neglect these purchasing chores until it is too late. Often, the investment of time and effort needed to search for and plan remaining purchases related to a first transaction, such as in case of travel, is inefficient in terms of the search, co-ordination and planning between various service providers that may be desired by a user. Many times, a planning and reservation process would require providing repetitive information, such as the same personal and family details for each portion of a trip or each separate transaction related to the trip, which can be a key deterrent for engaging in detailed planning. Delaying timely planning may prove costly in terms of increasing restrictions such as limited or non-availability of preferred dates, choice of service (e.g. Premium, Economy class), and a related increase in pricing of preferred services as travel dates get closer. Thus, inefficiencies in the transactional system impose a direct penalty on users, whereas proper advance planning can reduce or even eliminate such penalties.

Certain services offered by vendors can be relevant to a user, but these parties may simply not be aware of each other. When it gets too close to a travel date, the user may be in a harried rush and settle for a less than perfect solution, or even be confronted with missing out on a desirable activity or product due to it being sold out. Meanwhile, merchants with relevant services that are good matches for a user may have services/seats go unfilled (e.g., a merchant who provides whale watching trips). By making effective use of payment token and transaction data, however, these inefficiencies can be ameliorated or resolved.

Thus, in some embodiments, a digital wallet can be used as a holding place for a main booking, and then utilized to complete additional services related to the booking. On the payments side, in some embodiments a single token with an end-party billing agreement (EPBA) and authorization (AUTH) may be stored, and used as many times as there are payments to be made. All of the AUTHs can be stored in a central digital wallet location, so that when services are rendered, each of these are captured by respective merchants (as used herein, a digital wallet may refer to a collection of one or more electronic payment mechanisms). Accordingly, a limited timespan single user market can benefit the experience of a user who is, for example, planning a travel vacation (where a series of details in putting an itinerary together may involve multiple purchases and payments to multiple vendors/merchants), or making any other purchase where related transactions may provide additional benefit. In the previously given travel example, anchor transactions that may serve to establish a limited timespan electronic market can include, but are not limited to, travel, hotel, auto bookings, upsell services like parking, attraction tickets, activity and tour guide booking, etc. Add-on transactions can in some embodiments reuse the original payment information via multiple follow on authorizations. Many different possible transactional situations are contemplated by the present disclosure, however, which is not limited to the above examples. Such a limited timespan electronic market can greatly reduce inefficiencies and the related penalties or detriments to a transacting user.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal etc.).

Various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. §112(f) for that component.

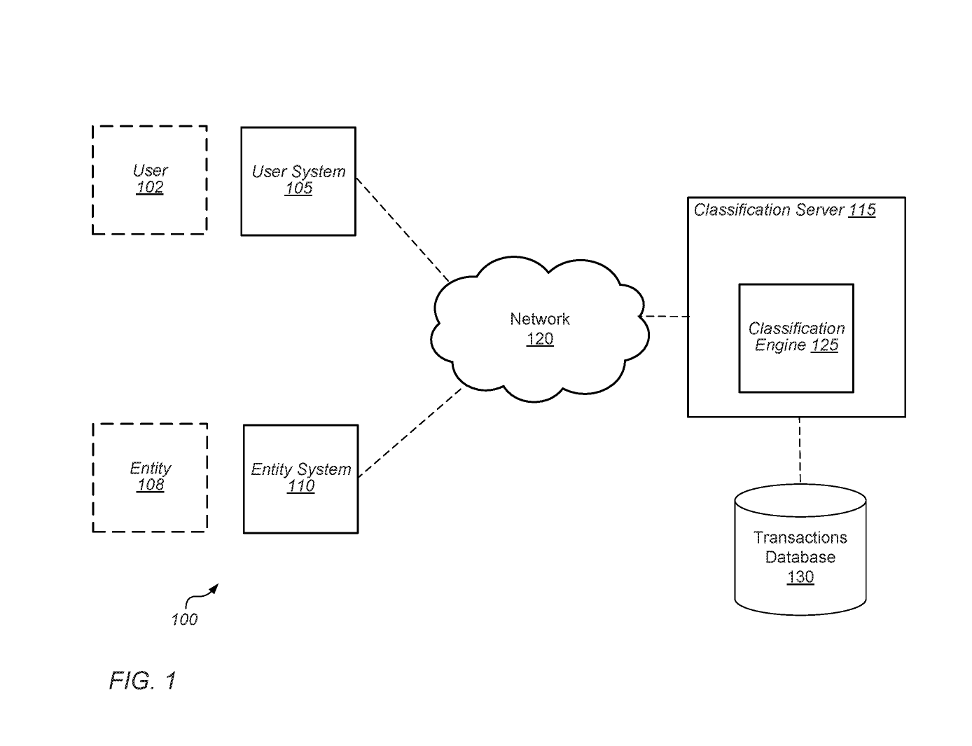

Turning to FIG. 1, a block diagram of a system 100 is shown. In this diagram, system 100 includes a user 102, user system 105, entity 108, entity system 110, and a classification server 115 that are connected via network 120. Classification server 115 includes a classification engine 125 in the embodiment shown, and is connected to transactions database 130. Each of the objects comprising FIG. 1 may be any suitable computer system, device, or collection of systems or devices in various embodiments (and may therefore each include one or more aspects of the system described below relative to FIG. 8).

User 102 may operate user system 105 to conduct electronic transactions over network 120. Thus, a user of user system 105 may purchase, for example, a plane ticket, activity tickets or reservations (e.g., baseball tickets, guided tour), or a travel reservation. Purchases made via user system 105 are not limited to such future events or services, however, and may include household items, cosmetics, clothing, electronics, vehicles, or any good or service. User system 105 may be a smartphone, laptop computer, desktop computer, wearable electronic device, augmented or virtual reality device, or other device, in various embodiments.

In conducting an electronic transaction, user 102 may have one or more particular goals in mind. Such goals may vary widely, depending on the good(s) and/or service(s) being purchased. For example, when buying plane tickets, a user's goal may be enjoying themselves on vacation. When buying expensive hiking boots, the user's goal may be personal comfort during extended time outdoors. In some instances, a user may have more than one goal related to a transaction.

Entity system 110 corresponds to entity 108 in the embodiment of FIG. 1. Entity system 110 may facilitate an electronic transaction in which user 102 makes a purchase from entity 108. Entity 108 may be a merchant, though in some instances, entity 108 may be any entity capable of engaging in a transaction (e.g., a friend, family member, or colleague selling something to user 102). Note that in some figures and/or description, user 102, entity 108, or other parties may be described or depicted without reference to a computer system—in such instances, a suitable computer system is still employed to perform various operations described or shown as being performed by those parties.

Classification server 115 is configured to receive transaction authorization requests from entity system 110 and/or user system 105 in various embodiments. Thus, classification server 115 may be a system operated by PAYPAL, INC. or another payments-related company. Classification server 115 may also have access to various transaction details (date, location, amount, good(s)/service(s) purchased, etc.) that are received from systems 105 and/or 110, and that may be stored in transactions database 130.

Network 120 includes the Internet in one embodiment, but may be any collection of one or more interconnected communications networks in various embodiments.

Thus, in at least one embodiment, a user 102 may conduct a transaction with an entity 108, for which payment information is sent to classification server 115. As further discussed below, classification server 115 may then use this payment information to establish a limited lifespan electronic market corresponding to user 102.

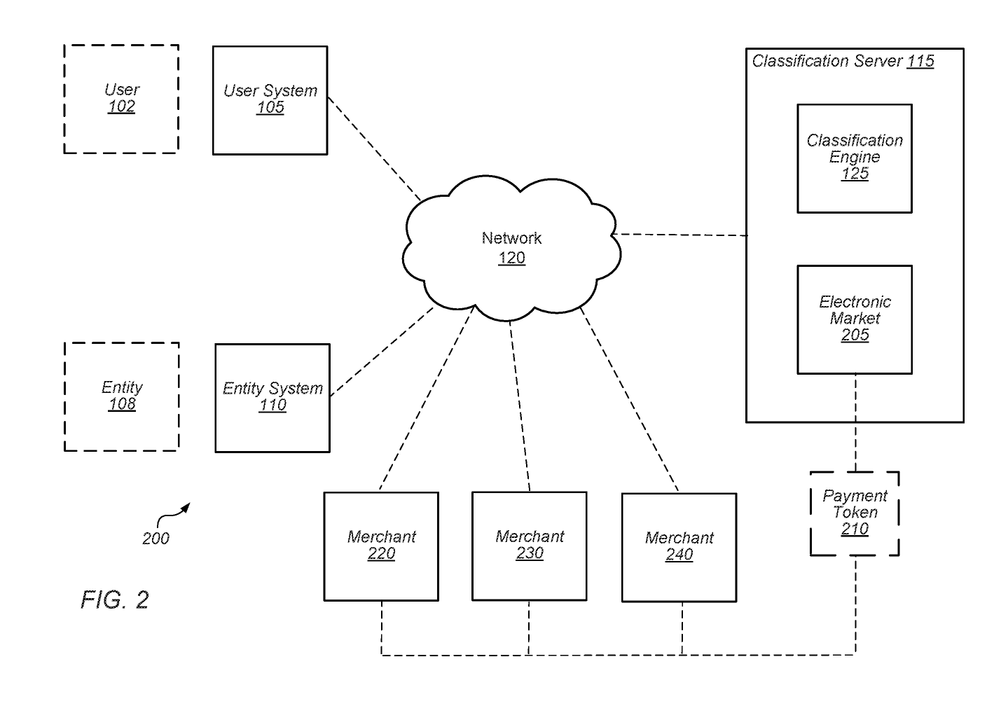

Turning to FIG. 2, a block diagram is shown of system 200 after a first transaction has been initiated between user 102 and entity 108. In this system, an electronic market 205 has been established by classification server 115 based on details of the first transaction.

As will be described in greater detail, electronic market 205 may be a limited timespan market. Thus, electronic market 205 will not exist in perpetuity, but will be de-established at a future point in time, in various embodiments. Merchants 220, 230, and 240 are participants in electronic market 205 in the embodiment shown.

Merchants 220, 230, and 240 may make offers to user 102 via electronic market 205 that relate to an approximated transaction goal for the user's first transaction. (Although not shown, each of merchants 220, 230, and 240 may have one or more associated computer systems configured to perform various operations that are described relative to merchants 220, 230, and 240. Also note that generally, as discussed herein, an action described as being performed by some party may be performed by a computer system corresponding to that party. Thus, a phrase such as “a merchant transmitting X data . . . ” may be understood as “a computer system, corresponding to a merchant, transmitting X data” as appropriate). Each of merchants 220, 230, and 240 may be chosen by an entity (e.g., classification server 115 and/or intermediary 305, discussed below) to participate in electronic market 205 based on a variety of factors. For example, merchants 220, 230, and 240 may have a pre-existing relationship with intermediary 305, or may submit bids to intermediary 305 offering an amount of compensation for the right to participate in electronic market 205.

Note that users, in various embodiments, can have various preference data regarding limited timespan electronic markets. A user may opt-in to participate in electronic market 205, or opt-out at any time. A user can also selectively turn off participation in electronic market 205, as desired. For example, a user may not wish to receive offers regarding electronic market 205 at a given time, but may want to retain the ability to participate in the market again at a future time. Thus, the user can temporarily halt participation in electronic market 205 (in addition to permanently withdrawing, if desired).

An approximated transaction goal, as discussed further below, can be any goal associated with a user's transaction. A user who purchases a round-trip ticket to Paris with a return flight 3 weeks later may have a goal of a relaxing French vacation. A user who purchases a mid-week round-trip ticket to London with a return flight 2 days later may instead have a goal of completing a business meeting or business deal. A user who purchases a 60″ television may have a goal of increasing their in-home entertainment. Meanwhile, a user who purchases a dozen 60″ televisions may have a goal of operating a sports bar or other entertainment venue. More than one goal is possible for a particular transaction. Thus, an “approximated transaction goal”, as that term is used herein, may refer to an estimated goal that is believed to be at least somewhat close to (or identical to) a user's actual goal for a transaction. Accordingly, this approximated transaction goal may be calculated based on available data, and may in some cases not match a goal that a user explicitly expresses. An approximated transaction goal may be generated regardless of whether or not the actual goal is consciously known to the user or explicitly expressed by the user.

In the embodiment of FIG. 2, a payment token 210 is shown in connection with electronic market 205 and merchants 220, 230, and 240. Payment token 210 corresponds to the first transaction between user 102 and entity 108 in this embodiment. As described further herein, electronic market 205 may be established using payment token 210 as a basis.

In some instances, all transactions within electronic market 205 use the same payment token 210 (which is linked to payment credentials of user 102), and each of merchants 220, 230, and 240 can potentially utilize payment token 210 to conduct a transaction via electronic market 205. Thus, payment token 210 may remain “live” for all or substantially all of the lifetime of electronic market 205.

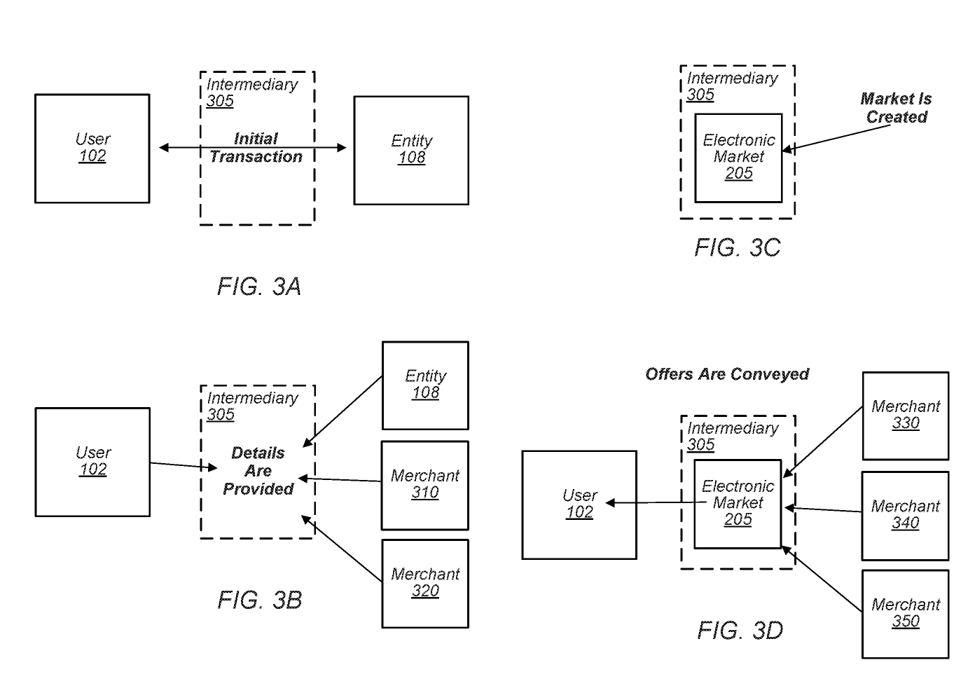

Turning to FIGS. 3A-3D, logical information flow diagram charts are shown illustrating certain high-level aspects of the present disclosure. These figures show information flow, relative to various parties, that can occur in association with the establishment and operation of limited lifespan electronic market 205.

In the embodiment of FIG. 3A, an initial transaction occurs between a user 102 and an entity 108. This transaction occurs via intermediary 305, which may be a company such as PAYPAL, INC. Intermediary 305 may be privy to information such as the transaction amount and other information about the good(s) and/or service(s) being purchased. Intermediary 305 is also privy to user account profile and past activities on that account, in various embodiments.

In FIG. 3B, various details are provided to intermediary 305. These can be details from user 102, such as demographic information, work information, home address, and various personal information such as ages and/or genders of family members, etc., that may, for example, be acquired in accordance with applicable privacy laws, other regulatory requirements, and the user's consent, in various embodiments. Further details may also be collected via entity 108 (with whom the user engaged in a transaction), merchant 310, and merchant 320. These details might relate to other transactions the user has previously initiated, for example, with other merchants in the past. Again, such information will be collected in accordance with applicable privacy laws, other regulatory requirements, and the user's consent in various embodiments. Intermediary 305 may thus have various detailed information about a recent purchase or other transaction and/or one or more other past purchases or other transactions.

In FIG. 3C, intermediary 305 creates limited timespan electronic market 205. As shown, limited timespan electronic market 205 is hosted by intermediary 305, but may be externally hosted in various embodiments. Creating limited timespan electronic market 205 is described in further detail below.

In FIG. 3D, various offers are presented to user 102 via electronic market 205. In this diagram, merchants 330, 340, and 350 all provide information to electronic market 205, which then creates or forwards offers to user 102. In some cases, merchants 330, 340, and 350 may provide specific offers (e.g., “product X is for sale at price Y”); in other cases, intermediary 305 may create an offer based on parameters sent by merchants 330, 340, and 350 (e.g., 20% off current retail price at whatever time a consumer engages the offer). Also note that while not shown, other entities may also participate in electronic market 205, such as merchants 310 or 320 (e.g., merchants the user may have previously transacted with). Further, the availability of products and services for electronic market 205 and offers related to those products and services are confirmed with merchant order and inventory systems, in one embodiment, to ensure a user is not served with an offer for something that is out of stock, for example (which could be a frustrating experience).

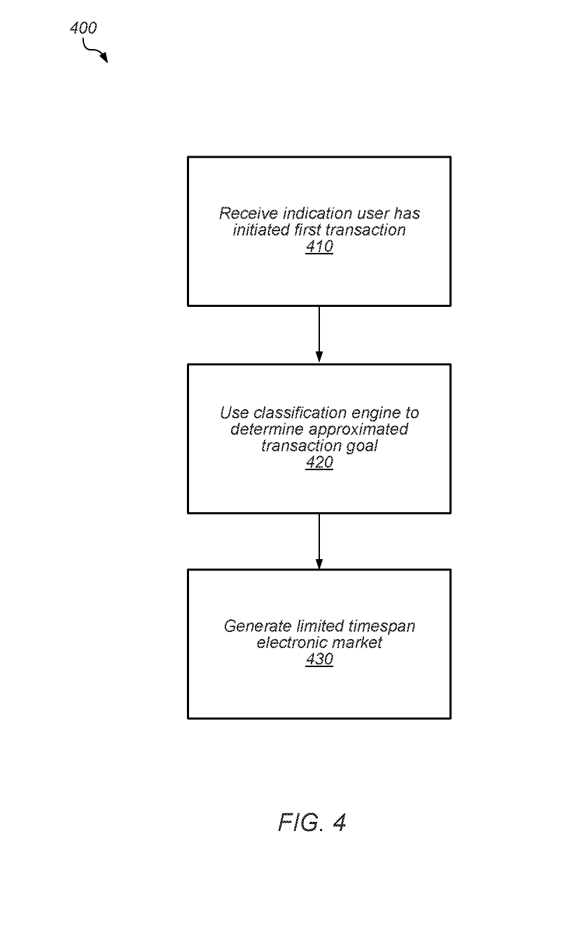

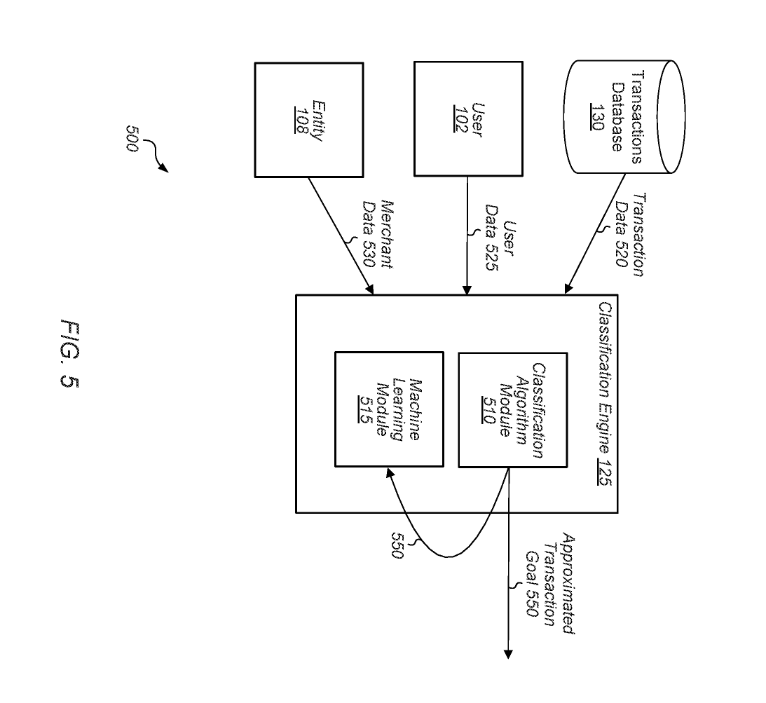

Turning to FIG. 4, a flowchart is shown of a method 400 relating to a limited timespan electronic market. The operations of method 400 are performed, in one embodiment, by classification server 115. In other embodiments, however, a different system may perform these operations.

In operation 410, classification server 115 receives information indicating a user has initiated a first transaction. User 102 initiating a transaction with entity 108, for example, may be indicated in the information received in operation 410.

The information in operation 410 may be a payment authorization request, in various instances. Entity system 110 may send a payment authorization request to classification server 115 (or another system in communication with classification server 115), for example. In general, all or part of the information received by classification server 115 in operation 410 may be received from user system 105, entity system 110, and/or another system.

In some cases, operation 410 may also include receiving information indicating that the first transaction has been approved. That is, in some cases, a purchase attempt may be disregarded unless the purchase is ultimately approved, as it may not make sense to establish limited timespan electronic market 205 for a purchase that is rejected, e.g., due to insufficient funds (if a user cannot complete this purchase, their transaction goals may be irrelevant).

Payment token information may be made available to classification server 115 as a result of operation 410. Classification server 115 may receive payment token information from entity system 110 (e.g., if a merchant already has a payment token on file), or classification server 115 may acquire a payment token by contacting a payment token vault system, payment network system, or another system configured to provide payment token information. A payment token associated with a first transaction between user 102 and entity 108 may correspond to a particular payment network, such as a network run by PAYPAL™, AMERICAN EXPRESS™ VISA™, MASTERCARD™, etc. Generally, a “payment token” may refer to any information or credentials that correspond to a particular user account (like the unique reference identifier of a digital wallet, a financial instrument or a unique financial instrument within the wallet) and allow a transaction to be processed at the expense of that particular user account. (Thus, a payment token may be a numeric string or alphanumeric string sixteen characters in length, in some embodiments, but may have other appearances in other embodiments.) A payment token therefore may comprise non-sensitive data that is used as a proxy or substitute for sensitive data (such as a primary account number). A tokenization system that corresponds to the payment token may be configured to both issue tokens and also reverse-map a token back to sensitive payment data that is being obscured through the use of the token. Even if a payment token is captured by a hostile party, for example, without access to the reverse-mapping system maintained by the tokenization system, the payment token will not allow an unauthorized party to be paid funds, in various embodiments.

In operation 420, classification server 115 determines an approximated transaction goal for the first transaction between user 102 and entity 108. This transaction goal is determined using classification engine 125 based on details of the first transaction, in one embodiment.

Additional detail regarding how classification engine 125 determines approximated transaction goals is provided below relative to FIG. 5. However, note that operation 420 may determine various different approximated transaction goals for different transactions. That is, depending on the particular circumstances of a specific transaction, different particular approximated transaction goals may be determined.

Classification engine 125 uses machine learning and artificial intelligence techniques, in some embodiments, that provide accurate estimations of one or more goals that a user may have when they engage in a transaction. (Note that as used herein, the term “classification engine” refers simply to executable program instructions and/or machines that perform one or more described tasks as described herein, and is not intended to imply any specific limitations relative to other possible external uses of this term.)

In operation 430, classification server 115 generates limited timespan electronic market 205. Electronic market 205 is generated based on the approximated transaction goal from operation 420, in one embodiment, and gives access to merchants 220, 230, and 240 to electronically communicate offers to user 102 for a variety of products or services corresponding to the approximated transaction goal. In some embodiments, merchants 220, 230, and 240 may not be given access to directly communicate offers through electronic market 205, but may instead be able to have offers presented through electronic market 205 on their behalf by another party, such as intermediary 305.

The lifetime of limited timespan electronic market 205 may correspond to a variety of factors. Thus, in various embodiments, different factors may affect the actual length of time that market 205 will exist. In one example, an electronic market 205 could be based on available seats for a live event such as a play. But if the play becomes sold out, then electronic market 205 may be closed. In another example embodiment, an electronic market 205 is closed when a user cancels the seed transaction for the market—e.g., if the user cancels their travel booking to New York City, electronic market 205 may be closed. Further, in another example, the life of electronic market 205 may be extended in response to updated transaction information—such as the user extending a hotel stay by another week (thereby signaling to marketplace merchants that additional offers within this timeframe may be of interest to the user). Electronic market 205 may also be updated when modified transaction information indicates a relevant change—e.g., if a second hotel room is added to a booking, then the user may be expecting more family or friends to join them (and offers may be updated accordingly).

In one embodiment, a payment token for the first transaction between user 102 and entity 108 has a time to live (TTL) value. This TTL value corresponds to a lifespan of electronic market 205 in this embodiment. For example, for a particular initial transaction between user 102 and entity 108, a payment token might have a TTL of 72 hours. In this example, electronic market 205 might therefore also have a lifespan of 72 hours, and/or be set up to expire at the same time as the payment token. (Many TTL values for a payment token are possible, from minutes or hours to days, weeks, or years.)

In some embodiments, one or more adjustment factors might be added to or subtracted from the lifespan of electronic market 205 (even when that lifespan corresponds to a TTL for the payment token). For instance, the lifespan of electronic market 205 could be maintained for a longer period of time to account for possible chargebacks or refunds occurring after the payment token expires.

Payment token 210 (and electronic market 205) may be short-lived in some cases, or quite long-lived in others. A multi-use payment token for a healthcare provider, for example, might allow for recurring charges over several years to provide care for a patient. (In such a case, ensuring the patient's physical well-being might be a goal of the first transaction between user 102 and entity 108 upon which limited timespan electronic market 205 is based).

Payment token 210 may have different characteristics and/or different formats in various embodiments and for various transactions. In one instance, payment token 210 is a token provided by PAYPAL, INC and corresponds to the PAYPAL payment network. Payment token 210 may correspond to any closed payment network, in various embodiments. Likewise, payment token 210 may correspond to an open payment network (e.g., VISA) in various embodiments.

A “captive” payment token, in some embodiments, refers to a payment token 210 that can only be used for a single merchant (who may offer multiple additional services via electronic market 205). A “house” payment token, in some embodiments, refers to a payment token 210 issued by intermediary 305. Captive and house payment tokens may have different sets of relevant policies information associated with them.

Turning to FIG. 5, a block diagram is shown of one embodiment of a system 500 that illustrates certain aspects of how classification engine 125 may determine an approximated transaction goal for a particular transaction between a first user (e.g., user 102) and a first entity (e.g., entity 108).

In particular, classification engine 125 may receive transaction data 520, user data 525, and merchant data 530, and feedback based on historical choices and patterns processed by machine learning module 515, and use some or all of this data as a basis for determining an approximated transaction goal 550.

In FIG. 5, classification engine 125 receives a variety of data, as shown on the left hand side of the figure. Transactions database 130 may send transaction data 520, for example. Transaction data 520 includes a variety of transaction details regarding past purchases that the first user and/or other users have participated in, in one embodiment. These details may include but are not limited to purchase amount, purchase location, descriptive information about item(s) purchased (cost, UPC, technical specifications relating to physical product characteristics or dimensions and/or technical specifications relating to internal electric or electronic configurations), location of service(s) purchased, merchant identifying information, merchant category code, identifying information of one or more individuals associated with a past transaction (e.g., other names on a travel or hotel itinerary), etc.

In some cases, transaction data 520 includes transaction details regarding purchases that other users have participated in. Such transaction details may be similar or the same to those described immediately above. Note that transaction data 520 may be anonymized (e.g. stripped of identifying markers) in various cases so as not to expose identifying information of other users. In some cases, transaction data 520 may also be aggregated to further avoid exposing identifying personal information. In one embodiment, transaction data 520 may be sourced from any available party willing to share or provide the data (per any applicable user consent needed). Thus, in some instances, the basis transaction for electronic market 205 need not be a transaction handled or facilitated by intermediary 305 (e.g., the basis transaction can be external to an entity that creates, operates, or manages electronic market 205). In such cases where an external transaction triggers the creation of electronic market 205, a new payment token may be instantiated for use in that marketplace (rather than re-using a token from the basis transaction, for example).

Transaction data 520 may be sent to classification engine 125 in response to an explicit request from classification engine 125, or may be pushed to classification engine 125 without an explicit request, in various cases. In one embodiment, transactions database 130 provides regular updates to classification engine 125 on a scheduled basis (e.g., daily, hourly, weekly). In some embodiments, transaction data 520 is explicitly requested by classification engine 125 in order to determine a particular approximated transaction goal. (Transactions database 130 may contain a very large amount of data, in some cases, and this would not all necessarily be sent to classification engine 125).

In the embodiment of FIG. 5, user data 525 is also utilized by classification engine 125 to determine an approximated transaction goal for a transaction between user 102 and entity 108. User data 525 is provided in accordance with applicable privacy laws, other regulatory requirements, and with user permission in various embodiments. Note that as above, user data can be sourced from any willing provider to enrich knowledge about one or more users, and is not necessarily limited to demographic, psychographic, geographic, behavioral, or product usage data, for example.

User data 525 can include any variety of information that personally pertains to user 102. Thus, user data 525 may include one or more of name, home address, work address, geographic regions associated with the user (places the user travels regularly for work, personal business, pleasure, childcare, shopping, gasoline purchases, etc.), identifying information about family members, housemates, or previous traveling companions.

User data 525 may also include various preference data, in various embodiments. (Note that such preference data can also be received from parties other than user 102, in one embodiment.) This preference data can include interests of the user, specific vendors or merchants that the user prefers to use for certain goods or services (e.g., Delta Airlines for air travel, Home Depot for hardware supplies, Hotwire.com for car rental, etc.), vendors or merchants that the user prefers NOT to use for certain goods or services (or not to use at all under any circumstances), etc. User data 525 may also include data relevant to a current or recent transaction (i.e., the transaction between user 102 and entity 108 for which an approximated transaction goal is being determined). User preference data, in one embodiment, is employed to determine which offers may be communicated to a user via electronic market 205 (i.e., if certain offers should be given higher or lower priority, or excluded entirely).

Merchant data 530 is also used by classification engine 125, in the embodiment of FIG. 5, to determine approximated transaction goal 550. Merchant data 530 can include any information submitted by user 102 or collected by entity 108 (relative to user 102) in various embodiments. This data can include information about past purchases that user 102 has made with entity 108 (items or services bought, dates of purchases, times of purchases, amounts of purchases, etc.) This data can include period purchase information as well, e.g., a trip to New York every summer to catch a Broadway play. In general, merchant data 530 may include similar or identical types of data item as transaction data 520, but that are specific to entity 108 rather than other entities, in at least one embodiment. Merchant data 530 may also include data relevant to a current or recent transaction (i.e., the transaction between user 102 and entity 108 for which an approximated transaction goal is being determined).

Transaction data 520, user data 525, and merchant data 530 are therefore provided as inputs to classification engine 125 in the embodiment of FIG. 5. Classification engine 125 then uses classification algorithm module 510 to determine approximated transaction goal 550 for a first transaction between user 102 and entity 108.

Classification algorithm module 510 comprises program instructions that are executable to determine approximated transaction goal 550, in one embodiment, by analyzing transaction data 520, user data 525, and/or merchant data 530. Accordingly, classification algorithm module 510 may give different weighting to various items of data 520, 525, and 530 in reaching an approximate transaction goal.

Note that while some discussion herein describes determining a single approximated transaction goal, classification engine 125 may generally determine one or more approximated transaction goals. Thus, a single purchase of round trip tickets might have approximated transaction goals of “vacation”, “beach trip”, and “family trip” that can be determined by classification algorithm module 510.

Approximated transaction goal 550 can be represented, in some embodiments, as one or more particular pre-specified categories or sub-categories. These categories may include options such as business trip, pleasure trip, live entertainment, physical fitness, home entertainment, transportation, etc. Certain categories may have sub-categories as well (live entertainment: concert, movie, sporting event, etc.). To build up an initial data set that can be used to determine approximated transaction goals, human review or surveys can be performed. (Thus, a user might be asked questions such as “for your airline trip on X date, was the primary purpose business, pleasure, or both?”). Likewise, a human reviewer could also assign categories based on available data. Merchant agents can also classify transaction goals manually based on available client history data (e.g., user seeks non-smoking seats near the window in a restaurant).

In other embodiments, approximated transaction goal 550 can be represented as a plurality of numeric values associated with different other goods or services that may be for sale. That is, approximated transaction goal 550 can be represented as a number of vectors each with a magnitude and direction toward some other potential transaction. As an example of this vector representation, approximated transaction goal 550 for an original purchase of a men's business suit could be represented as a group of related transaction potentials:

Related purchase of business shoes, $75 or more: +100

Related purchase of dark socks: +60

Related purchase of silk tie: +85

Related purchase of leather belt: +50

Related purchase of cloth belt: −30

Related purchase of t-shirt, $10 or less: −80

Related purchase of woman's silk blouse: −150

In this example, the purchase of expensive business shoes is highly correlated with an original purchase of a men's business suit, while purchasing a woman's blouse is highly negatively correlated (that is, based on an analysis of transaction data, someone who just purchased a men's business suit is highly unlikely to purchase a woman's silk blouse in the near future.) Further, per machine learning module 515, if we learn that a user who has purchased a men's business suit actually does buy a woman's silk blouse (generally unlikely in the example above), the user can be prompted with follow-up questions to gain additional information about his or her purchases to help provide additional feedback to improve classification algorithm module 510.

While the above is just a short abbreviated example, many different potential related transactions can be assessed by classification algorithm module 510, particularly when it has access to a large amount of other transaction data by other users. Further, note that as discussed above, users can be solicited for additional information to help refine classification algorithm module 510. As one example, a user can be asked “based on your recent purchase, we are guessing you are going on a pleasure trip to Hawaii. Is this correct or incorrect? (Select one)”. The user can also be asked about past purchases as well, e.g., “based on your purchase of a riding lawn mower on Jun. 3, 2016, we are guessing you own your own home and like maintaining your yard yourself. Is this correct or incorrect?” (Many other different possible types of user feedback may be solicited relative to transaction goal determination.)

Thus, classification engine 125 may generally determine that certain data would be helpful for the transaction goal determination, and request such data from transactions database 130 accordingly. Thus, transaction data requested or used by classification engine 125 may pertain to one or more particular criteria used by a goal classification algorithm. These criteria may match one or more characteristics of the particular transaction for which a transaction goal is being approximated, as illustrated by the example further below.

As one example of data use in determining an approximated transaction goal, consider a round trip plane travel purchase. In this example, user 102 is traveling round trip from San Jose, Calif. to Austin, Tex. on a ticket purchased from entity 108. In this case, data used by classification engine 125 to determine a transaction goal might include transaction data 520 that pertains to other round trip plane trips purchased by other users to the same destination city (Austin, Tex.). The transaction data 520 might also include, for other users who made a trip to Austin, items or services that were purchased in Austin on date(s) of that trip. If 90% of previous purchasers of airfare to Austin also purchased a rental car, then approximated transaction goal 550 is likely to relate to a car rental (e.g., business trip or personal trip requiring auto transport). If only 0.2% of previous purchasers of airfare to Austin were known to have bought tickets to go on a nearby winery tour, however, then approximated transaction goal 550 may be unlikely to relate to wine tours.

Lesser weighting could also be given to certain transaction data that appears relevant, but not as directly relevant as other transaction data. For example, analysis of transactions by users who travel to Austin might give those transactions a relative weighting (importance) of 100. Analysis of transactions by users who travel to other near cities, like San Antonio, Houston, and Dallas might receive lesser respective weightings of 75, 60, and 50. (In one embodiment, geographic closeness of transaction locations could result in a sliding scale factor being used; thus, distances of a first range (e.g., 0-50 miles) could get a first weighting, while distances of a second range (e.g., 51-100 miles) could get a second weighting, and so on.)

Days of the week, months of the year, holiday timing, etc. may also cause other transactions to be variously weighted. If user 102 leaves San Jose for Austin on a Tuesday and returns on a Thursday, weekday transactions of other users may be more heavily weighted relative to weekend transactions of other users. A weekday traveler may be more likely to have a business oriented transaction goal (e.g., a business meeting or conference) than a weekend traveler, for example. Thus, by weighting other past weekday purchases more heavily than past weekend purchases, approximated transaction goal 550 may be more accurately determined by classification engine 125.

In general, when determining approximated transaction goal 550, classification engine 125 may be interested in factors such as (1) previous purchases by the current user 102; (2) previous purchases by other similarly situated users; and (3) merchant or other data. As illustrated above, different weightings for these factors may be used in various circumstances.

In weighting previous purchases by the current user or a similarly situated users, any discernable transaction attribute of a previous transaction may be compared to a corresponding transaction attribute of the present transaction for which approximated transaction goal 550 is being determined. All other transactions might start with a relative weight (e.g., 100) but then have that weight increased or decreased based on similarities or differences between the user and another user and/or between transactions.

To continue the airline example shown above, consider the user who has purchased a round trip ticket from San Jose to Austin, leaving Tuesday, returning Thursday. Any other user who has flown from San Jose to Austin in the last 6 months, departing on a Tuesday, and returning on Thursday, may have their other analyzed transactions initially weighted at 100 due to the strong similarities between their situation and user 102. Other users with minor differences could receive slightly lower initial weightings on their transactions—e.g., a user who flew from San Jose to Austin 10 months ago, departing on a Monday, and returning on a Friday may have other analyzed transaction initially weighted at 95. Various weighting matrices and/or lists can be used to specify weighting factors (the amount to increase or decrease weightings based on absolute or relative differences between transaction attributes).

Classification engine 125 can likewise accordingly determine one or more characteristics of one or more prospective future transactions related to a user goal for a first transaction between user 102 and entity 108. If the user goal is personal fitness, for example, characteristics of one or more prospective future transactions can include an indication that the prospective future transaction relates to outdoor or fitness equipment, a gym membership, yoga classes, Lululemon pants, etc. Merchants can then participate in electronic market 205 and communicate offers that correspond to at least one of the one or more characteristics, in various embodiments.

Thus, as described above, in the embodiment of FIG. 5, classification engine 125 determines an approximated transaction goal for a particular transaction between user 102 and entity 108 based on data inputs that include transaction details regarding a plurality of purchases by a plurality of other users. Determining an approximated transaction goal may be a complex task, however, and classification engine 125 may therefore also employ intelligent machine learning techniques to improve its estimations.

### Machine Learning for Transaction Goal Classification

Machine learning module 515 may receive any or all of the data that is input to classification algorithm module 510, and may update classification algorithm module 510 based on this and other data received subsequent to the determination of approximated transaction goal 550. (Thus, another input to machine learning module 515 is approximated transaction goal 550.)

Broadly, machine learning module 515 is capable of taking approximated transaction goal 550, and then based on subsequent information, determining if that approximated transaction goal was accurate. Based on this feedback mechanism, classification algorithm module 510 is updated so that as time goes on, goal classifications can become increasingly precise and relevant. Accordingly, in one embodiment, classification engine 125 is updated with details regarding a first transaction between user 102 and entity 108 as well as details of one or more transactions initiated by the user subsequent to initiating the first transaction.

Machine learning module 515 may therefore first obtain a predicted approximated transaction goal, then analyze a variety of transactions in the future. As an example, consider the above example of user 102 purchasing round trip plane tickets from San Jose to Austin, arriving on a Tuesday and departing on a Thursday. An initial approximated transaction goal for this transaction may be “business trip.”

When those dates of travel arrive and user 102 goes to Austin, he or she may engage in a number of other transactions which can then be analyzed. For example, user 102 may make a purchase of $103 from a barbecue restaurant in Austin at 10:45 on Wednesday morning, a purchase of $25 from a record store at 1:30 pm, and a purchase of $42 from a bar at 3:48 pm on Wednesday. Based on this pattern of purchases, machine learning module 515 may determine that a transaction goal for user 102 was not “business trip” but was in fact “pleasure trip/vacation” (because a user on a business trip would be unlikely to engage in such a pattern of activity). Classification algorithm module 510 can then be updated to reflect that the user's earlier purchase should have been classified as a pleasure trip, in this example.

Further, when using machine learning module 515 to update classification algorithm module 510, specific transaction information can be data mined to indicate potential transactions that other future users might be interested in pursuing via electronic market 205. Machine learning module can correlate the earlier purchase by user 102 (the plane tickets to Austin) to the later purchases made in Austin during the trip (barbecue, record store, and bar purchases). Other purchases made by users who flew to Austin on trips can then be aggregated to provide more accurate predictive power. Out of 1,000 users who travel to Austin mid-week, for example, 600 might purchase barbecue, 350 might make a purchase at a bar, and 85 might make a purchase at a record store. This data would show a strong predictive correlation that the next person to buy a mid-week plane ticket to Austin is more likely than not (60%) to be interested in dining at a barbecue restaurant. It may be highly desirable for a particular merchant to then provide that future user an offer related to barbecue via an electronic market established based on the airline purchase. (Note that in some scenarios, making such a detailed determination about potential future transactions would be difficult, since transaction details may not always be available. An open payment network, for example, might only know an amount of purchase and/or a merchant category code. However, in various embodiments, intermediary 305 may have a great deal more visibility about transactions that have occurred.)

In another embodiment, classification server 115 can track conversion of offers presented to user 102 via electronic market 205 and provide those results to classification engine 125. If user 102 is presented with offers A, B, C, and D, for example, but only purchases offer B, then this information can be recorded. After many users are presented with such offers relative to a number of different limited timespan electronic markets, offer conversion information can be aggregated and used by machine learning module 515 to help update classification algorithm module 510.

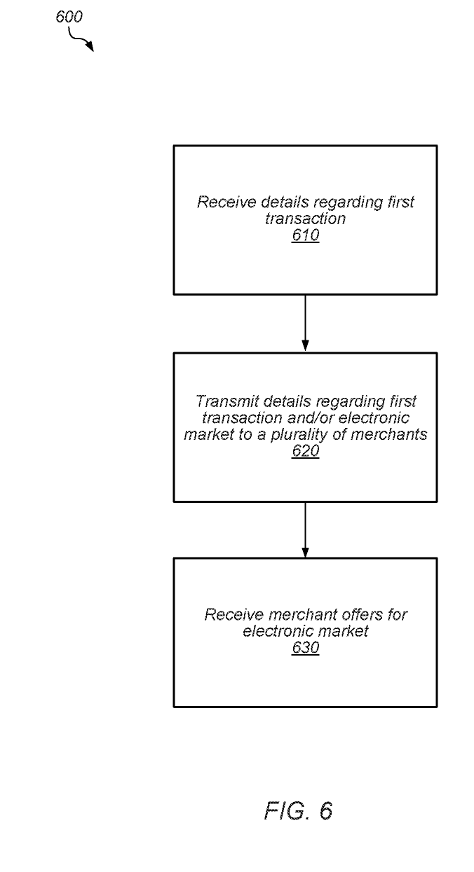

Turning to FIG. 6, a flow diagram of one embodiment of a method 600 is shown. In this method, a system such as classification server 115 (or any suitably configured system) may receive transaction details, share information with merchants, and receive merchant offers for electronic marketplace 205. Thus, in method 600, merchants may learn details about an “anchor” transaction that forms the basis for electronic market 205, and be able to use those details to determine what products and/or services they may be able to solicit to user 102 via electronic market 205.

In operation 610, classification server 115 receives details regarding a first transaction between user 102 and entity 108. These details may include purchase price, descriptive information about goods and/or services purchases, date of purchase, time of purchase, time of future delivery of goods and/or services, etc.

In operation 620, classification server 115 transmits details regarding the first transaction and/or details regarding electronic market 205 to a plurality of merchants. This operation may therefore include sharing any or all of the transaction details received in operation 610 (again, subject to any applicable privacy rules, regulations, or laws). Details regarding electronic market 205 may include additional information, such as a length of time that electronic market 205 will exist (lifespan), information about an approximated transaction goal for user 102, and/or user information about user 102 (such as user data 525).

In operation 630, classification server 115 receives offers for electronic market from various merchants. These offers may be personalized to user 102 based on information about the transaction upon which electronic market 205 is based, and/or may be personalized based on other known information about user 102.

These offers may be presented to user 102 through any number of channels. User 102 logging into a PAYPAL or other financial account, for example, may result in the offers being presented on a web page, email, text, or other alert/notification. In some embodiments, offers may be presented to a user via other channels (e.g., existing advertising channels on a site not owned by intermediary 305 or one of the merchants making the offer) based on cross-linked identifying information such as cookies.

In one embodiment, operation 630 includes the merchants soliciting bids for offer placement to classification server 115. The solicitation may specify monetary amounts to be paid by the merchant to intermediary 305 for the offer being shown to user 102 and/or monetary amounts to be paid by the merchant if the offer is accepted.

### Broadcasting Marketplace Identifier and Soliciting in Realtime

In one embodiment, operation 630 includes transmitting a market category identifier to a plurality of merchants corresponding to electronic market 205. This market category identifier may identify one or more characteristics of electronic market 205 that will allow the merchants to determine if they wish to have an offer included in the electronic market. For example, hashtags could be broadcasts to merchants such as #AUSTINFAMILYVACATION, #SF49ERSGAME, #NEWCAR, etc. (respectively referring to a family vacation in Austin, someone attending a San Francisco 49ers NFL game, and someone purchasing a new automobile). As will be appreciated, many possible market category identifiers/descriptors can be defined.

Electronic market 205 may be updated, in some embodiments, with additional transaction information pertaining to one or more other transactions initiated subsequent to a first transaction between user 102 and entity 108. This updating may cause user 102 to be presented with recent availability status on offers based on the additional information. For example, consider a user that has purchased a new car, leading to the establishment of electronic market 205. If the user then buys a ski rack that can be mounted on top of the new car, electronic market 205 could be updated with new offers regarding to ski rental, ski purchase, outdoor winter apparel, ski resort hotels and reservations, etc. (Many different scenarios are possible, however, outside of this illustrative example.)

User-provided hashtags (or other information) can also be shared with merchants who participate in electronic market 205. For example, a savvy user could append his or own hashtag to a transaction to indicate a specific purpose. Intermediary 305 can also suggest transaction hashtags based on history (e.g., #DISNEYFAMILY, #FAMILYREUNION, #HAWAIIANHONEYMOON, #LASVEGASFRIENDS). Social media accounts can also be accessed (with user permission) to discover the nature of an upcoming trip or additional relevant details (e.g., possible travel companions who will accompany the user). Generally, such hashtags may help cement a mutual agreement on the purpose of a user's transaction goal and eliminates guessing. This specificity drives more conversion of offers in marketplace 205 and provides an advantage over previously known techniques.

### Post-Purchase Feedback

Post-purchase feedback from a user can help inform the formation of future electronic marketplaces and algorithms that are used to determine offer presentment to users via electronic marketplace 205. A user can give a rating on an offer in electronic marketplace 205, for example, regarding the usefulness or relevance of that offer (e.g., “on a 1-10 scale, how relevant was this offer to your interests?”). Capturing this rating information can then allow intermediary 305 to adjust the priority of other offers in existing or future marketplaces (e.g., users who bought a riding lawn mower have recently indicated that offers for lawn mower blade sharpening services are not particularly relevant; thus, such offers may be presented to other similarly situated users at a lesser rate (or not at all)).

Further, post-purchase user feedback about a merchant may also affect algorithms used to create future electronic marketplaces (or affect the presentation of offers in existing or future marketplaces). As one example, a user could be asked to rate his overall satisfaction with a merchant on a scale of 1-10 for a particular add-on transaction that occurred through electronic market 205. A user who rates a merchant “1” (lowest) might then be noted as uninterested in that merchant (and no more offers from that merchant will be presented, under the assumption the user's negative experience will greatly reduce the odds of the user buying from that merchant again). Conversely, a user who rates a merchant highly (e.g., 8, 9, or 10) may receive offers from that merchant at an increased rate and/or preferentially have those offers displayed first or more prominently than other offers from other merchants.

### Computer-Readable Medium

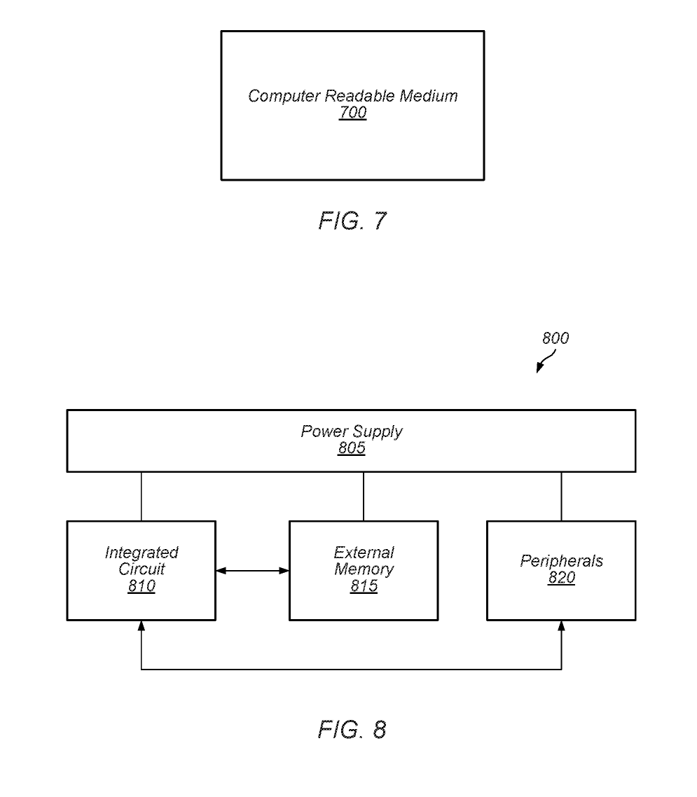

Turning briefly to FIG. 7, a block diagram of one embodiment of a computer-readable medium 700 is shown. This computer-readable medium may store instructions corresponding to the operations of FIG. 4, FIG. 5, FIG. 6 and/or any techniques described herein. The program instructions may be stored on a non-volatile medium such as a hard disk or FLASH drive, or may be stored in any other volatile or non-volatile memory medium or device as is well known, such as a ROM or RAM, or provided on any media capable of staring program code, such as a compact disk (CD) medium, DVD medium, holographic storage, networked storage, etc. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a server or server system such as, for example, in C, C+, HTML, Java, JavaScript, or any other scripting language, such as VBScript. Note that as used herein, the term “computer-readable medium” refers to a non-transitory computer readable medium.

### Computer System

In FIG. 8, one embodiment of a computer system 800 is illustrated. Various embodiments of this system may be a user system, merchant system, a server system, or any other computer system as discussed above and herein.

In the illustrated embodiment, system 800 includes at least one instance of an integrated circuit (processor) 810 coupled to an external memory 815. The external memory 815 may form a main memory subsystem in one embodiment. The integrated circuit 810 is coupled to one or more peripherals 820 and the external memory 815. A power supply 805 is also provided which supplies one or more supply voltages to the integrated circuit 810 as well as one or more supply voltages to the memory 815 and/or the peripherals 820. In some embodiments, more than one instance of the integrated circuit 810 may be included (and more than one external memory 815 may be included as well).

The memory 815 may be any type of memory, such as dynamic random access memory (DRAM), synchronous DRAM (SDRAM), double data rate (DDR, DDR2, DDR6, etc.) SDRAM (including mobile versions of the SDRAMs such as mDDR6, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit 810 in a chip-on-chip configuration, a package-on-package configuration, or a multi-chip module configuration.

The peripherals 820 may include any desired circuitry, depending on the type of system 800. For example, in one embodiment, the system 800 may be a mobile device (e.g. personal digital assistant (PDA), smart phone, etc.) and the peripherals 820 may include devices for various types of wireless communication, such as wifi, Bluetooth, cellular, global positioning system, etc. The peripherals 820 may also include additional storage, including RAM storage, solid state storage, or disk storage. The peripherals 820 may include user interface devices such as a display screen, including touch display screens or multitouch display screens, keyboard or other input devices, microphones, speakers, etc. In other embodiments, the system 800 may be any type of computing system (e.g. desktop personal computer, server, laptop, workstation, net top etc.). Peripherals 820 may thus include any networking or communication devices necessary to interface two computer systems.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, by a computer system, information indicating a user has initiated a first transaction with an entity;
based on details of the first transaction, using a classification engine running on the computer system to determine an approximated transaction goal for the first transaction; and
generating, by the computer system and based on the approximated transaction goal, a limited timespan electronic market that provides access to a plurality of merchants to electronically communicate offers to the user for a plurality of products or services corresponding to the approximated transaction goal.

2. The method of claim 1, wherein the information indicating the user has initiated the first transaction includes a payment token corresponding to a payment network;
wherein the payment token has a time to live (TTL) value corresponding to a lifespan of the limited timespan electronic market.

3. The method of claim 1, wherein the classification engine determines the approximated transaction goal based on data inputs that include transaction details regarding a plurality of purchases by a plurality of other users.

4. The method of claim 1, wherein determining an approximated transaction goal for the first transaction includes assigning a first weighting to a parameter of the first transaction and a second weighting to a corresponding parameter of a second transaction that was initiated by a different user.

5. The method of claim 1, wherein determining an approximated transaction goal for the first transaction includes comparing one or more details of the first transaction to one or more corresponding details of a previous transaction initiated by another user, wherein the one or more details include at least one of a date of purchase, a good or service purchased, an amount of purchase, a time of purchase, a day of the week of purchase, or a geographic location associated with a purchase.

6. The method of claim 1, further comprising causing, by the computer system, the classification engine to be updated with details regarding the first transaction and details of one or more transactions initiated by the user subsequent to initiating the first transaction.

7. The method of claim 1, further comprising transmitting a market category identifier corresponding to the limited timespan electronic market to the plurality of merchants.

8. The method of claim 1, further comprising receiving, by the computer system, a plurality of details regarding the first transaction; and
transmitting one or more of the plurality of details to one or more merchants.

9. The method of claim 8, wherein the plurality of details include a cost of a product or service and one or more of the following that are associated with the product or service: a geographic location, a date, a range of dates, a time, a range of times, descriptive information regarding one or more characteristics of the product or service, a brand, or identifying information about one or more persons corresponding to the product or service.

10. A non-transitory computer-readable medium having stored thereon instructions that are executable to cause a computer system to perform operations comprising:
receiving payment token information indicating a user has initiated a first transaction with an entity;
based on details of the first transaction, using a classification engine to determine an approximated transaction goal for the first transaction; and
generating a limited timespan electronic market that provides access to a plurality of merchants to electronically communicate offers to the user for a plurality of products or services corresponding to the approximated transaction goal.

11. The non-transitory computer-readable medium of claim 10, wherein the operations further comprise:
subsequent to the first transaction being completed using the payment token information, causing a second transaction to be completed using the limited timespan electronic market and the payment token information.

12. The non-transitory computer-readable medium of claim 10, wherein the operations further comprise:
updating the limited timespan electronic market with additional transaction information; and
causing the user to be presented with updated offers based on the additional transaction information.

13. The non-transitory computer-readable medium of claim 10, wherein the operations further comprise:
tracking conversion of offers presented to the user via the limited timespan electronic market; and
providing results of the tracking to the classification engine.

14. The non-transitory computer-readable medium of claim 10, wherein the operations further comprise:
receiving bids, from the plurality of merchants, to solicit the user with content related to the first transaction.

15. The non-transitory computer-readable medium of claim 10, wherein the operations further comprise causing the payment token information to be used with two or more purchases with two or more of the plurality of merchants via the limited timespan electronic market.

16. A system, comprising:
a processor; and
a storage device having stored thereon instructions that are executable by the processor to cause the system to perform operations comprising:
receiving payment token information that indicates a user has initiated a first transaction with an entity;
based on details of the first transaction, using a classification engine running on the system to determine one or more characteristics of one or more prospective future transactions related to a user goal for the first transaction; and
generating, based on the one or more characteristics, a limited timespan electronic market that provides access to a plurality of merchants to electronically communicate offers to the user for a plurality of products or services corresponding to the one or more characteristics.

17. The system of claim 16, wherein the operations further comprise maintaining a plurality of limited timespan electronic markets that correspond to a plurality of users, wherein each of the limited timespan electronic markets is accessible by the system using a respective payment token for that market.

18. The system of claim 16, wherein the operations further comprise processing a plurality of transactions involving two or more of the plurality of merchants via the limited timespan electronic market and using the payment token information.

19. The system of claim 16, wherein the operations further comprise:
accessing a plurality of transaction details over a period of time for a plurality of transactions involving a plurality of users; and
updating one or more weighting factors for the classification engine based on correlations between earlier ones and later ones of the plurality of transactions.

20. The system of claim 19, wherein updating the one or more weighting factors includes analyzing, for individual ones of the plurality of users, a particular respective transaction of that user relative to a particular group of respective transactions of that user that were initiated at a later time than the particular respective transaction.
